(19) United States
(12) Patent Application Publication
(10) Pub. No.: US 2025/0105938 A1
(43) Pub. Date: Mar. 27, 2025

(54) Accuracy monitoring of clock synchronized systems

(71) Applicant: MELLANOX TECHNOLOGIES, LTD., Yokneam (IL)

(72) Inventors: Natan Manevich, Nesher (IL); Dotan David Levi, Kiryat Motzkin (IL); Maciej Machnikowski, Reda (PL); Wojciech Wasko, Mlynek (PL); Elran Abissror, Yokneam (IL); Bar Or Shapira, Tel Aviv (IL); Pavel Efros, Tzur Izhak (IL); Jonathan Oliel, Ramat Gan (IL); Ofir Sadeh, Shoham (IL)

(21) Appl. No.: 18/475,297

(22) Filed: Sep. 27, 2023

(51) Int. Cl. H04J 3/14; H04J 3/06

(52) U.S. Cl. CPC H04J 3/14; H04J 3/0667

(57) ABSTRACT

In one embodiment, a monitoring device includes an interface to receive symbols from at least one monitored device over at least one communication link, at least one counter to track a number of the symbols received from the at least one monitored device over the at least one communication link, and processing circuitry to monitor synchronization of at least one clock of the at least one monitored device based on at least one value of the at least one counter.

### FIELD OF THE INVENTION

The present invention relates to computer systems, and in particular, but not exclusively, to monitoring clock synchronization.

### BACKGROUND

Clock synchronization among network devices is used in many network applications. One application of using a synchronized clock value is for measuring one-way latency from one device to another device. If the clocks are not synchronized the resulting one-way latency measurement will be inaccurate. Synchronization is typically achieved by syntonization, in which the clock frequency of two devices is aligned, and aligning the phase between the two devices.

For Ethernet, there are two complementary methods to achieve synchronization. One is Synchronous Ethernet (SyncE), which is a physical-layer protocol which achieves syntonization based on the receive/transmit symbol rate. SyncE is an International Telecommunication Union Telecommunication (ITU-T) Standardization Sector standard for computer networking that facilitates the transference of clock signals over the Ethernet physical layer. In particular, SyncE enables clock syntonization inside a network with respect to a master clock.

The other is Precision Time Protocol (PTP), which is a packet-based protocol that may be used with SyncE to align offset (e.g., in Coordinated Universal Time (UTC) format) and phase between two clocks. It should be noted that PTP may be used alone over Ethernet (without SyncE), but this is typically used for lower accuracy use cases. PTP is used to synchronize clocks throughout a computer network, and is considered to be the de facto standard for this purpose.

Time, clock, and frequency synchronization are crucial in some modern computer network applications. It enables 5G and 6G networks, and is proven to enhance the performance of data center workloads.

### SUMMARY

There is provided in accordance with an embodiment of the present disclosure, a monitoring device, including an interface to receive symbols from at least one monitored device over at least one communication link, at least one counter to track a number of the symbols received from the at least one monitored device over the at least one communication link, and processing circuitry to monitor synchronization of at least one clock of the at least one monitored device based on at least one value of the at least one counter.

Further in accordance with an embodiment of the present disclosure the at least one counter is configured to track the number of the symbols received from multiple monitored devices, and the processing circuitry is configured to monitor a relative synchronization of clocks of the monitored devices based on at least one value of the at least one counter.

Still further in accordance with an embodiment of the present disclosure the interface is configured to send symbols to the at least one monitored device, the at least one counter is configured to track the number of symbols received from, and sent to, the at least one monitored device, and the processing circuitry is configured to monitor synchronization of the at least one clock of the at least one monitored device based on the number of symbols received from, and sent to, the at least one monitored device.

Additionally in accordance with an embodiment of the present disclosure the at least one counter includes a first counter to track the number of symbols received from, the at least one monitored device, and a second counter to track the number of symbols sent to the at least one monitored device, and the processing circuitry is configured to monitor synchronization of the at least one clock of the at least one monitored device based on a first value of the first counter and a second value of the second counter.

Moreover, in accordance with an embodiment of the present disclosure the processing circuitry is configured to compute an error value of the at least one clock of the at least one monitored device based on to the number of symbols received from, and sent to, the at least one monitored device as tracked by the at least one counter.

Further in accordance with an embodiment of the present disclosure the processing circuitry is configured to perform an action responsively to the error value exceeding a given threshold.

Still further, in accordance with an embodiment of the present disclosure the processing circuitry is configured to provide a software interface to allow software to monitor the synchronization of the at least one clock of the at least one monitored device.

Additionally in accordance with an embodiment of the present disclosure the software interface is configured to receive an instruction from the software to reset the at least one counter, the processing circuitry being configured to reset the at least one counter responsively to receiving the instruction.

Moreover, in accordance with an embodiment of the present disclosure the software interface is configured to receive a request from the software for a current or average error value or history of the at least one clock, wherein the software interface is configured to provide the current or average error value or history of the at least one clock to the software.

Further in accordance with an embodiment of the present disclosure the software interface is configured to receive a request from the software to provide periodic error reports of at least one error of the at least one clock, wherein the software interface is configured to provide the periodic error reports to the software.

Still further in accordance with an embodiment of the present disclosure the software interface is configured to receive an error threshold from the software, wherein the software interface is configured to provide a report to the software responsively to an error of the at least one clock exceeding the error threshold.

Additionally in accordance with an embodiment of the present disclosure the processing circuitry is configured to generate and provide a report responsively to monitoring the synchronization.

Moreover, in accordance with an embodiment of the present disclosure the processing circuitry is configured to monitor synchronization of respective clocks of respective monitored devices based on values of the at least one counter.

Further in accordance with an embodiment of the present disclosure the processing circuitry is configured to detect an anomaly in one of the monitored devices responsively to comparing the values of the at least one counter.

Still further in accordance with an embodiment of the present disclosure, the device includes a hardware clock, and synchronization circuitry to cause synchronization of the at least one clock of the at least one monitored device to be synchronized to the hardware clock.

Additionally in accordance with an embodiment of the present disclosure, the device includes a network interface controller or a network switch or a data processing unit (DPU).

Moreover, in accordance with an embodiment of the present disclosure, the device includes a processor to execute software to plot a graph of clock error of the at least one clock of the at least one monitored device over time. Further in accordance with an embodiment of the present disclosure, the device includes a hardware clock including an oven-controlled crystal oscillator or an atomic clock.

Still further, in accordance with an embodiment of the present disclosure, the device includes a hardware clock, and synchronization circuitry to discipline the hardware clock from a remote device.

Additionally in accordance with an embodiment of the present disclosure the synchronization circuitry is configured to discipline the hardware clock from a pulse per second signal received from a Global navigation satellite system (GNSS) receiver.

Moreover, in accordance with an embodiment of the present disclosure the at least one communication link includes at least one of network connection, or a data communication bus.

There is also provided in accordance with another embodiment of the present disclosure, a monitoring method, including receiving symbols from at least one monitored device over at least one communication link, tracking a number of the symbols received from the at least one monitored device over the at least one communication link, and monitoring synchronization of at least one clock of the at least one monitored device based on the tracked number of the symbols.

### BRIEF DESCRIPTION OF THE DRAWINGS

The present invention will be understood from the following detailed description, taken in conjunction with the drawings in which:

FIG. 1 is a block diagram view of a clock synchronization monitoring system constructed and operative in accordance with an embodiment of the present invention;

FIG. 2 is a flowchart including steps in a method of operation of the system of FIG. 1;

FIGS. 3-4 are flowcharts including steps in methods of providing reports in the system of FIG. 1;

FIG. 5 is a flowchart including steps in an anomaly detection method in the system of FIG. 1; and

FIGS. 6-7 are flowcharts including steps in error detection methods in the system of FIG. 1.

### DESCRIPTION OF EXAMPLE EMBODIMENTS

### Overview

Certain systems require high precision timing. In such systems, it is important for the hardware clock of the processing device to be accurately synchronized. For example, when a host hardware clock is synchronized to the hardware clock of a connected network device, synchronization software running on the host device may malfunction leading to a clock drift (from the network device clock) greater than an acceptable limit. Without additional information, the host device and/or network device may assume the worst-case scenario, and assume that the clock drift of the host hardware clock is too large, and act on the assumption that the host clock is not synchronized enough to perform certain time critical tasks (e.g., database updates).

Embodiments of the present invention address some of the above drawbacks by providing a monitoring device that monitors clock synchronization of one or more monitored devices based on a symbol rate of data received from the monitored device(s) and optionally based on a symbol rate of data sent by the monitoring device.

Clock monitoring may provide a measure of clock frequency error of one of the monitored devices relative to one or more other monitored devices and/or to the clock frequency of the monitoring device. The term “monitor synchronization”, in all grammatical forms, as used in the specification and claims, may include checking that the clock frequencies of the clocks running on the monitored device(s) are within given limits. The monitoring may include comparing the various symbol rates (described in more detail below) to identify an anomaly, and/or initiate an action, or providing an alert or error report.

The clock(s) of the monitored device(s) may be synchronized to the clock of the monitoring device using a given clock synchronization method, such as SyncE and/or PTP or Precision Time Measurement (PTM). However, if the clock synchronization method fails (e.g., due to a software crash) the monitoring device may still be able to monitor the clock synchronization of the monitored device(s) using the above monitoring. In some embodiments, the clock(s) of the monitored device(s) may be synchronized to another device, and not to the clock of the monitoring device. Whether or not the clock(s) of the monitored device(s) are synchronized to the clock of the monitoring device using a given clock synchronization method, the term “monitoring” includes performing clock synchronization monitoring independently of the given clock synchronization method used by the monitored device(s) to discipline the clock(s) of the monitored device(s) such that the monitoring method includes steps that are different to the steps of the given clock synchronization method.

The hardware clock of the monitoring device may be disciplined to a remote clock, such as a remote PTP clock or any remote clock over a network, or to a time supplied by a Global navigation satellite system (GNSS). Where applicable, the monitored device(s) clock(s) may be synchronized to the monitoring device hardware clock using any suitable method, for example, by exchanging clock synchronization messages using a suitable clock synchronization method, such as Precision Time Measurement (PTM) or PTP. The synchronization of the monitored device(s) hardware clock(s) to the monitoring device hardware clock may generally performed via an interface between the devices such as a data communication bus, operating according to any suitable protocol, e.g., Peripheral Component Interconnect Express (PCIe), or via a network connection.

In some embodiments, the monitoring device monitors the synchronization of the clock of the monitored device based on a difference between a count of symbols sent by the monitoring device over a physical layer of a link between the monitoring device and the monitored device and a count of symbols received by the monitoring device from the monitored device over the link. Since the rate at which symbols are sent by a device is based on the clock frequency of the clock of that device, the count of the symbols is a measure of the clock frequency and therefore provides a way to monitor the clock frequency of a remote clock. The sent and received symbols may be counted using different counters for sent and received symbols or using the same counter which counts the difference between the sent and received symbols. The link may be a network link or a data communication bus link, or any suitable highspeed connection.

In the above manner, the monitoring device may monitor the clock frequency synchronization of multiple monitored devices based on the symbols received from the multiple monitored devices and the symbols sent to the multiple monitored devices.

In some embodiments, the monitoring device may monitor a relative clock frequency synchronization of multiple monitored devices based comparing the count of symbols received from the multiple monitored devices by the monitoring device.

In some embodiments, the monitoring device may detect an anomaly among the symbol counts to identify one (or more) of the multiple monitored devices with a clock error. For example, the monitored device associated with the symbol count with the highest deviation from the average symbol count may be identified as having a clock error. In some cases, the monitoring device may also include its sent symbol count in the above analysis to determine if the monitoring device has the clock error.

In some embodiments, when a monitored device is locked to the monitoring device, the monitoring device hardware receives a reset command and resets internal counters which indicate the number of transmitted and received symbols. After the reset, the hardware is aware of the synchronization quality of the monitored device by subtracting the two counters, which hold the number of transmitted and received symbols. The resulting number, indicating symbol difference, may be then converted to different units, such as: bits, bytes, time (for example, nanoseconds, picoseconds, etc.). The conversion to time is derived from the interconnect protocol and link speed, which provide how long it takes to transmit a chunk of data, such as a bit or a byte, through the interconnect. For example, an Ethernet link of 100 Gbps bandwidth, which is split into 4 lanes of 25 Gbps each, uses the typical 64b/66b line encoding standard. Therefore, for every 64 bits which needs to be transmitted, 2 bits will be added for Clock Data Recovery (CDR) on the other side. The number of data bits transmitted every second on each lane is 25 Gbps, and therefore the total number of bits would be 25 billion*66/64=25.78125 billion bits. The time it takes for a single bit to be transmitted can then be calculated by bit transmit time=1000*1 billion (picoseconds in a second)/25.78125 billion=38.79 picoseconds. Therefore, byte transmit time=8*single bit transmit time=310.3 Pico seconds.

In some embodiments, the monitoring device may monitor the accumulated time error of the monitored device at any given moment.

In some embodiments, the hardware of the monitoring device exposes a software interface to software running in the monitoring device or in a host device or peripheral device connected to the monitoring device. The software may request the hardware to reset the counter(s) via the software interface. In some embodiments, the software may poll the hardware via the software interface for the current clock error, with any of the units discussed above, such as time. In some embodiments, the software may poll the hardware via the software interface for the average error in a certain measurement window. In some embodiments, the software may request that the hardware via the software interface enter a periodic polling mode, in which the hardware sends an event (e.g., current clock error) to the software at a given time interval, for example, every 10 milliseconds. In some embodiments, the software may set an error threshold via the software interface, so that the hardware notifies the software whenever the error passes the threshold. For example, whenever the clock of the monitored device drifts from the clock of the monitoring device by more than 10 nano seconds, in either direction. The above may allow objective and continuous monitoring, and detect a misbehaving monitored device, even if for some reason a monitored device is not aware of its synchronization quality. For example, if the clock synchronization software/daemon running on the monitored device crashes or otherwise misbehaves.

In some embodiments, further actions may be performed whenever the monitoring device determines that the clock synchronization of the monitored device is not accurate enough. For example, a system of the monitored device may be excluded from certain operations in the network which require accurate synchronization, such as accessing a distributed database.

In some embodiments, the monitoring device may monitor clock synchronization of multiple monitored devices at the same time, as long as the internal hardware of the monitoring device supports such parallel operation. For example, the monitoring device may include one or more dedicated counters for each network port connected to the monitored device. This way, for example, a network switch may monitor clock synchronization of all the devices connected to the switch.

Dedicated test equipment can be very expensive, since it usually includes proprietary hardware. The monitoring device may be used to build physical layer clock syntonization test equipment, e.g., SyncE test equipment, by using commodity hardware of a network device to monitor clock synchronization over time. The test equipment of the monitoring device may be used to generate test equipment data, such as plotting a graph of the time error between the systems over time. The data can further be analyzed and used for validation of the different clock synchronization standards. For example, a standard may dictate that the time error accumulated in every 1000 second window should not be greater than 10 nanoseconds. Implementing such test equipment may help the development process, and replace dedicated test equipment systems in some cases. To make the monitoring device more precise, as expected from a test equipment system, high accuracy oscillators may be used, such as Oven Controlled Crystal Oscillator (OCXO) or an atomic clock. The monitoring device may even be connected to an external source which will provide additional accuracy and stability, such as pulse per second (PPS) signal from a Global navigation satellite system (GNSS) receiver, such as Global Positioning System (GPS).

### System Description

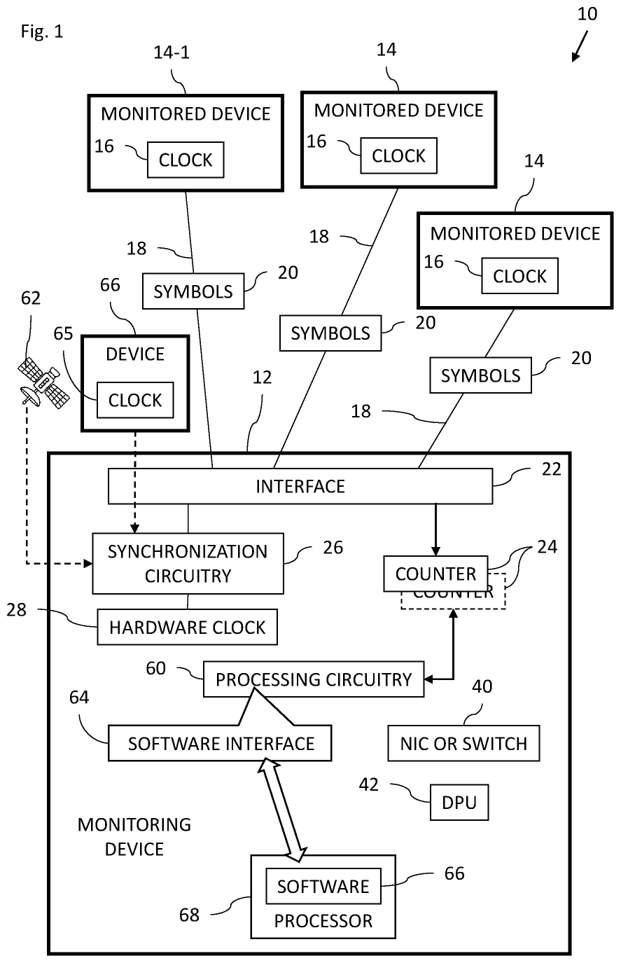

Reference is now made to FIG. 1, which is a block diagram view of a clock synchronization monitoring system 10 constructed and operative in accordance with an embodiment of the present invention. System 10 includes a monitoring device 12 and one or more monitored devices 14. Each monitored device 14 includes a clock 16, e.g., hardware clock running at a clock frequency and maintaining a clock time (e.g., a counter value or a time-of-day value). The monitoring device 12 is configured to monitor synchronization of the clocks 16 of the monitored devices 14 as described in more detail below.

The system 10 also includes communication links 18 connecting the monitored devices 14 with the monitoring device 12. The communication links 18 may include a network connection and/or a data communication bus or any suitable highspeed communication link. The monitored devices 14 and the monitoring device 12 are configured to exchange data with each other and the data is exchanged using symbols 20 sent at a symbol rate. The rate that symbols are sent by each of the monitored devices 14 and the monitoring device 12 is a function of the clock frequency of that device 14, 12. In other words, the rate that symbols are sent by monitored device 14-1 is a function of the clock frequency of the clock 16 of monitored device 14-1, and so on.

The monitoring device 12 includes an interface 22, one or more counters 24, synchronization circuitry 26, a hardware clock 28, and processing circuitry 30. The interface 22 is configured to send symbols to, and receive symbols from, the monitored devices 14. The interface 22 may include a network interface and/or a peripheral bus interface, by way of example.

The synchronization circuitry 26 is configured to discipline the hardware clock 28 from a remote device, which is generally not one of the devices 14 being monitored by the monitoring device 12. The synchronization circuitry 26 may be configured to discipline the hardware clock 28 from a pulse per second signal received from a Global navigation satellite system (GNSS) receiver 32 or from any suitable device, such as a device 33 (for example, a networking device or another device connected to monitoring device 12 via one of the communication links 18) including a hardware clock 35. In some embodiments, synchronization circuitry 26 is configured to cause synchronization of the clock(s) of the monitored device(s) 14 to be synchronized to the hardware clock 28. In other embodiments, the clocks 16 of the monitored devices 14 are synchronized to a different remote device and not to the hardware clock 28 of the monitoring device 12. The hardware clock 28 is configured to run at a clock frequency and maintain a clock time (e.g., a counter value or a time-of-day value). The hardware clock 28 may include an oven-controlled crystal oscillator or an atomic clock.

The processing circuitry 30 is configured to provide a software interface 34 to allow software 36 (running on a processor 38) to monitor the synchronization of the clock(s) 16 of the monitored device(s) 14. In some embodiments, the monitoring device 12 includes the processor 38. In other embodiments, the processor 38 is comprised in a host device or a peripheral device connected to the monitoring device 12. In some embodiments, the monitoring device 12 may include a network interface controller or a network switch 40 and/or a data processing unit (DPU) 42.

In practice, some, or all of the functions of the processing circuitry 30 may be combined in a single physical component or, alternatively, implemented using multiple physical components. These physical components may comprise hard-wired or programmable devices, or a combination of the two. In some embodiments, at least some of the functions of the processing circuitry 30 may be carried out by a programmable processor under the control of suitable software or firmware. This software or firmware may be downloaded to a device in electronic form, over a network, for example. Alternatively, or additionally, the software or firmware may be stored in tangible, non-transitory computer-readable storage media, such as optical, magnetic, or electronic memory.

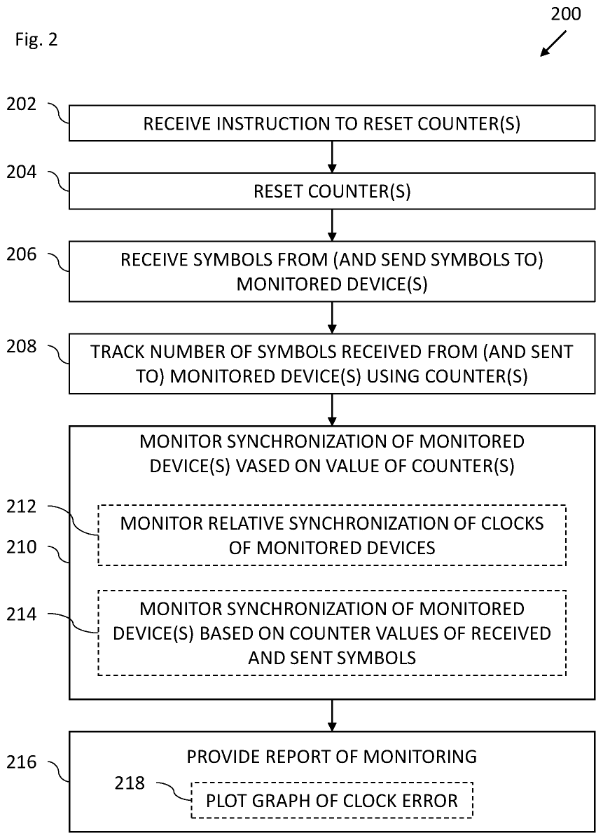

Reference is now made to FIG. 2, which is a flowchart 200 including steps in a method of operation of the system 10 of FIG. 1. The software interface 34 is configured to receive an instruction from the software 36 (via software interface 34) to reset the counter(s) 24 (block 202). The processing circuitry 30 is configured to reset the counter(s) 24 responsively to receiving the instruction (block 204).

The interface 22 is configured to receive symbols 20 from the monitored device(s) 14 over the communication link(s) 18 and send symbols 20 to the monitored device(s) 14 over the communication link(s) 18 (block 206).

One of the counters 24 (referred to herein as first counter) may be configured to track a number of the symbols 20 received from one of the monitored devices 14 over one of the communication links 18. Another one of the counters 24 (referred to herein as second counter) may be configured to track a number of the symbols 20 sent to that monitored device 14 over that communication link 18 (block 208). Therefore, a set of two counters 24 may be assigned to each of the monitored devices 14 to track the number of symbols 20 sent to, and received from, that monitored device 14.

In some embodiments, a single one of the counters 24 may be configured to track the net number of symbols 20 received from, and sent to, one of the monitored devices 14 over one of the communication links 18. Therefore, a single counter 24 may be assigned to each of the monitored devices 14 to track the net number of symbols 20 sent to, and received from, that monitored device 14.

The processing circuitry 30 is configured to monitor synchronization of the clock 16 of one of the monitored devices 14 based on the value(s) of the counters 24 tracking the symbols 20 received by the monitoring device 12 from the monitored device(s) 14 (and sent by the monitoring device 12 to that monitored device 14) (block 210), as described in more detail below. In some embodiments, the processing circuitry 30 is configured to monitor synchronization of respective clocks 16 of respective ones of the monitored devices 14 based on values of the counters 24.

In some embodiments, the processing circuitry 30 is configured to monitor a relative synchronization of clocks 16 of the monitored devices 14 based on the values of the counters 24 (block 212). For example, the counters 24 may track the number of symbols 20 received from the monitored devices 14, and based on the relative values of the counters 24 tracking the received symbols 20, the processing circuitry 30 is configured to compute a relative synchronization of the monitored devices 14 (e.g., to determine which of the monitored devices 14 is furthest from an average value of the counters 24).

In some embodiments, the processing circuitry 30 is configured to monitor synchronization of the clock 16 of one of the monitored devices 14 based on the number of symbols received from, and sent to, that monitored device 14 based on the value of one of the counters 24 or based on the values of the first counter and the second counter (block 214). For example, if one counter is tracking the net number of symbols received from, and sent to, that monitored device 14, the counter value is indicative of the difference between the frequency of the clock 16 of the monitored device 14 and the frequency of the hardware clock 28 of the monitoring device 12. For example, if two counters are tracking the number of symbols received from, and sent to, that monitored device 14, respectively, the difference in values of the two counters is indicative of the difference between the frequency of the clock 16 of the monitored device 14 and the frequency of the hardware clock 28 of the monitoring device 12.

In some embodiments, the processing circuitry 30 is configured to generate and provide a report responsively to monitoring the synchronization (block 216). The report may include any suitable data about the synchronization of the clock(s) 16 of the monitored device(s) 14, such as a current or average error value, a history of the clock 16 frequency and/or synchronization error, and so on. In some embodiments, the processor 38 (based on data received from the processing circuitry 30) is configured to execute software 36 to plot a graph of clock error of the clock(s) 16 of the monitored device(s) 14 over time (block 218).

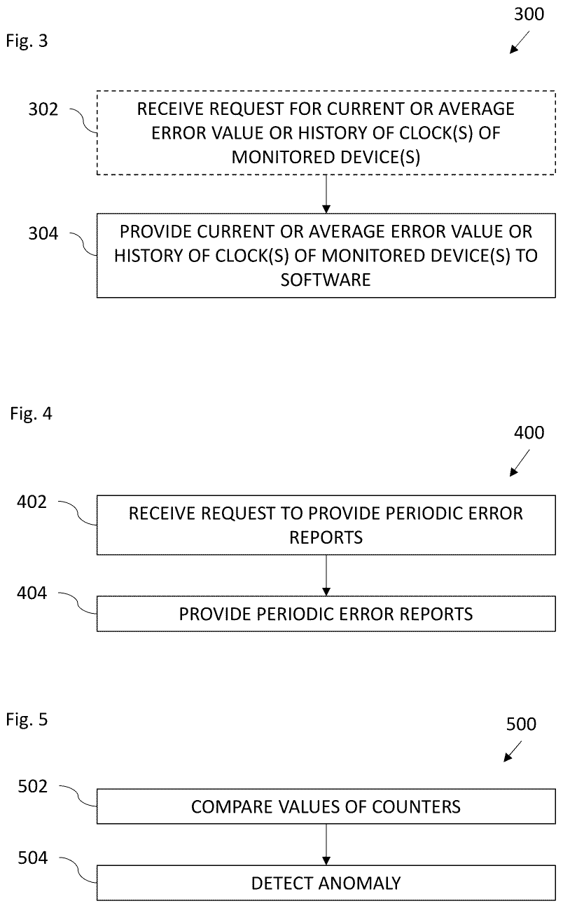

Reference is now made to FIGS. 3-4, which are flowcharts including steps in methods of providing reports in the system 10 of FIG. 1.

FIG. 3 shows a flowchart 300. The software interface 34 is configured to receive a request from the software 36 for a current or average error value of one or more of the clocks 16 or (an error) history of one or more of the clocks 16 (block 302). The processing circuitry 30 is configured to receive the request and compute the current or average error and/or retrieve historical error data. The software interface 34 is configured to provide the current or average error value or error history of the clock(s) 16 to the software 36 (block 304).

FIG. 4 shows a flowchart 400. The software interface 34 is configured to receive a request from the software 36 to provide periodic error reports of error(s) of one or more of the clocks 16 (block 402). The processing circuitry 30 is configured to receive the request and prepare the periodic error reports. The software interface 34 is configured to provide the periodic error reports to the software 36 (block 404).

Reference is now made to FIG. 5, which is a flowchart 500 including steps in an anomaly detection method in the system 10 of FIG. 1. In some embodiments, the processing circuitry 30 is configured to compare values of the counters 24 of different ones of the monitored devices 14 tracking symbols 20 received from the monitored devices 14 (block 502). The processing circuitry 30 is configured to detect an anomaly in one of the monitored devices 14 responsively to comparing the values of the counters 24 (block 504) or data derived from the values of the counters 24. The anomaly may be detected by comparing the values of the counters 24 and identifying a value (or values) which exceeds a given limit (e.g., percentage or standard deviation or other statistical measure) from the other values. In some embodiments, the counter tracking symbols 20 sent by the monitoring device 12 may also be included in the comparison of counter values to determine the anomaly, as in some cases the monitoring device 12 may have the clock with the anomaly. In some cases, more than one of the monitored devices 14 may be identified as having a clock with an anomaly.

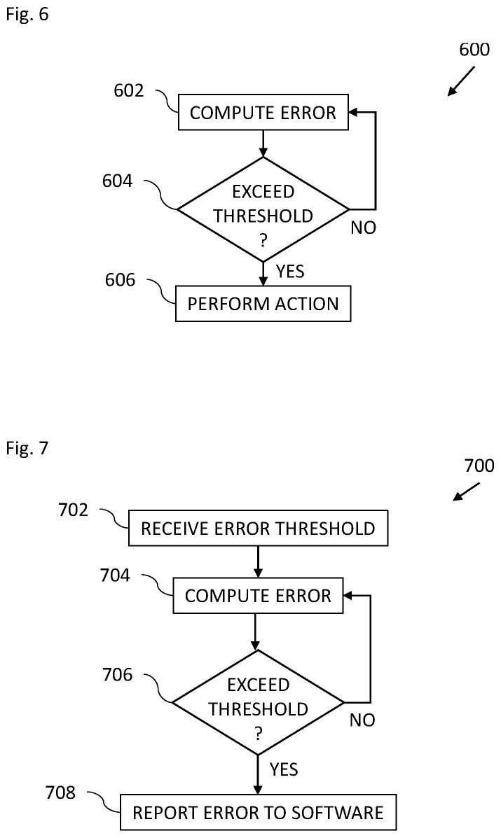

Reference is now made to FIGS. 6-7, which are flowcharts including steps in error detection methods in the system 10 of FIG. 1.

FIG. 6 shows a flowchart 600. The processing circuitry 30 is configured to compute an error value (or values) of the clock(s) 16 of one of the monitored devices 14 (or more than one of the monitored devices 14) based on the number of symbols received from, (and sent to,) the monitored device(s) 14 as tracked by one or more of the counters 24 (block 602). The error value associated with one of the clocks 16 may be computed relative to the hardware clock 28 of the monitoring device 12 or with respect to the clocks 16 of other ones of the monitored devices 14. The processing circuitry 30 is configured to determine at a decision block 604 if the error value(s) exceeds a threshold. If the error value(s) exceeds the threshold, the processing circuitry 30 is configured to perform an action (block 606), such as to prevent the monitored device 14 (associated with the clock 16 having the error value exceeding the threshold) updating a database.

FIG. 7 shows a flowchart 700. The software interface 34 is configured to receive an error threshold from the software 36 (block 702). The processing circuitry 30 is configured to receive the threshold, and compute an error value (or values) of the clock(s) 16 of one of the monitored devices 14 (or more than one of the monitored devices 14) based on to the number of symbols received from, and sent to, the monitored device(s) 14 as tracked by one or more of the counters 24 (block 704). The error value associated with one of the clocks 16 may be computed relative to the hardware clock 28 of the monitoring device 12 or with respect to the clocks 16 of other ones of the monitored devices 14. The processing circuitry 30 or the software interface 34 is configured to determine at a decision block 706 if the error value(s) exceeds the threshold. If the error value(s) exceeds the threshold, the software interface 34 is configured to provide a report of the error to the software 36 (block 708).

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A monitoring device, comprising:
an interface to receive symbols from at least one monitored device over at least one communication link;
at least one counter to track a number of the symbols received from the at least one monitored device over the at least one communication link; and
processing circuitry to monitor synchronization of at least one clock of the at least one monitored device based on at least one value of the at least one counter.

2. The device according to claim 1, wherein:
the at least one counter is configured to track the number of the symbols received from multiple monitored devices; and
the processing circuitry is configured to monitor a relative synchronization of clocks of the monitored devices based on at least one value of the at least one counter.

3. The device according to claim 1, wherein:
the interface is configured to send symbols to the at least one monitored device;
the at least one counter is configured to track the number of symbols received from, and sent to, the at least one monitored device; and
the processing circuitry is configured to monitor synchronization of the at least one clock of the at least one monitored device based on the number of symbols received from, and sent to, the at least one monitored device.

4. The device according to claim 3, wherein:
the at least one counter includes:
a first counter to track the number of symbols received from, the at least one monitored device; and
a second counter to track the number of symbols sent to the at least one monitored device; and
the processing circuitry is configured to monitor synchronization of the at least one clock of the at least one monitored device based on a first value of the first counter and a second value of the second counter.

5. The device according to claim 3, wherein the processing circuitry is configured to compute an error value of the at least one clock of the at least one monitored device based on to the number of symbols received from, and sent to, the at least one monitored device as tracked by the at least one counter.

6. The device according to claim 5, wherein the processing circuitry is configured to perform an action responsively to the error value exceeding a given threshold.

7. The device according to claim 1, wherein the processing circuitry is configured to provide a software interface to allow software to monitor the synchronization of the at least one clock of the at least one monitored device.

8. The device according to claim 7, wherein the software interface is configured to receive an instruction from the software to reset the at least one counter, the processing circuitry being configured to reset the at least one counter responsively to receiving the instruction.

9. The device according to claim 7, wherein the software interface is configured to receive a request from the software for a current or average error value or history of the at least one clock, wherein the software interface is configured to provide the current or average error value or history of the at least one clock to the software.

10. The device according to claim 7, wherein the software interface is configured to receive a request from the software to provide periodic error reports of at least one error of the at least one clock, wherein the software interface is configured to provide the periodic error reports to the software.

11. The device according to claim 7, wherein the software interface is configured to receive an error threshold from the software, wherein the software interface is configured to provide a report to the software responsively to an error of the at least one clock exceeding the error threshold.

12. The device according to claim 1, wherein the processing circuitry is configured to generate and provide a report responsively to monitoring the synchronization.

13. The device according to claim 1, wherein the processing circuitry is configured to monitor synchronization of respective clocks of respective monitored devices based on values of the at least one counter.

14. The device according to claim 13, wherein the processing circuitry is configured to detect an anomaly in one of the monitored devices responsively to comparing the values of the at least one counter.

15. The device according to claim 1, further comprising:
a hardware clock; and
synchronization circuitry to cause synchronization of the at least one clock of the at least one monitored device to be synchronized to the hardware clock.

16. The device according to claim 1, further comprising a network interface controller or a network switch or a data processing unit (DPU).

17. The device according to claim 1, further comprising a processor to execute software to plot a graph of clock error of the at least one clock of the at least one monitored device over time.

18. The device according to claim 1, further comprising a hardware clock including an oven-controlled crystal oscillator or an atomic clock.

19. The device according to claim 1, further comprising:
a hardware clock; and
synchronization circuitry to discipline the hardware clock from a remote device.

20. The device according to claim 19, wherein the synchronization circuitry is configured to discipline the hardware clock from a pulse per second signal received from a Global navigation satellite system (GNSS) receiver.

21. The device according to claim 1, wherein the at least one communication link comprises at least one of: network connection; or a data communication bus.

22. A monitoring method, comprising:
receiving symbols from at least one monitored device over at least one communication link;
tracking a number of the symbols received from the at least one monitored device over the at least one communication link; and
monitoring synchronization of at least one clock of the at least one monitored device based on the tracked number of the symbols.
